(19) United States
(12) Patent Application Publication
(10) Pub. No.: US 2021/0007552 A1
(43) Pub. Date: Jan. 14, 2021

(54) Fry Basket with Ergonomic Handle

(71) Applicant: Francisco Tanaka, DULUTH, GA (US)

(72) Inventor: Francisco Tanaka, DULUTH, GA (US)

(21) Appl. No.: 16/925,044

(22) Filed: Jul. 9, 2020

Related U.S. Application Data
(60) Provisional application No. 62/871,777, filed on Jul. 9, 2019.

(51) Int. Cl. A47J 37/12

(52) U.S. Cl. CPC A47J 37/1295; A47J 37/1276

(57) ABSTRACT

A fry basket with ergonomic handle is provided. The fry basket with ergonomic handle has a plurality of wires forming a wire frame. The wire frame defines a base receptacle that retains and receives a wire mesh basket therein. The base receptacle has a pair of open sidewalls, a lower front wall, a higher rear wall, and an upper open horizontal wall. The plurality of wires of the higher rear wall converge as they extend upwardly to form a generally vertical connection portion that connects the higher rear wall to a handle portion. The handle portion, in turn, extends rearwardly from the higher rear wall at a zero-degree angle with respect to at least one upper horizontal wire of the upper open horizontal wall. The handle portion also has a grip portion.

### CROSS REFERENCE TO RELATED APPLICATIONS

This application claims the benefit of U.S. Provisional Application No. 62/871,777 filed on Jul. 9, 2019. The above identified patent application is herein incorporated by reference in its entirety to provide continuity of disclosure.

### BACKGROUND OF THE INVENTION

The present invention relates to wire baskets used to fry food. More particularly, the present invention provides for a wire framework that can retain and receive a wire mesh basket therein, the framework having an ergonomic handle portion and grip in order to provide more comfort for prolonged periods of time, thereby reducing the chance for the user to develop fatigue or injury while manipulating the wire basket.

Many individuals prepare food by frying it in oil. One method of such preparation includes placing the food into a wire basket, submerging the basket and food into a hot oil bath, and then removing the basket with food after the food is cooked. Typical baskets include a wire mesh that retains the food as it fries in the oil. A wire handle typically extends rearwardly from the basket to enable the user to grip and manipulate the basket without touching any hot surfaces. Over the span of a cooking session, multiple baskets may be used to prepare a variety of foods, or in a restaurant setting, multiple baskets may be used to prepare multiple portions of the same food.

Devices have been disclosed in the known art that relate to wire baskets used to fry food. These include devices that have been patented and disclosed in patent application publications. Wire baskets, while useful for frying food, have numerous problems in terms of use. For example, the wire handle of a typical wire basket is often difficult to grip comfortably. The angle of inclination of the handle of a wire basket with respect to the basket itself places the user's wrist in an awkward position. The user must grasp the handle in a manner that requires the hand, wrist, and forearm to be out of alignment, and constant usage of the basket in this awkward position can cause fatigue or injury to the user's tendons, muscles, and ligaments.

The wires of a typical wire basket handle are similar in size to the user's tendons but are much harder and less flexible. This disparity can cause injury and fatigue to the tendons over time because prolonged use of the typical wire handle irritates and inflames the tendons of the user. Some wire handles include a greater tilt angle with respect to the horizontal upper opening of the fry basket. This design can exacerbate muscle and tendon fatigue and injury that can be caused by using the fry basket repeatedly. With these designs, the user must twist their wrist, rotate their arm, and apply force to lift the basket out of the hot oil bath. The force on the twisted muscles and tendons can cause even greater injury or fatigue. Additionally, the rigid wire handles of typical wire baskets are notoriously uncomfortable to grasp and maneuver and can cause pain when the user repetitively moves the basket filled with food material.

The present invention substantially diverges in design elements from the known art and consequently it is clear that there is a need in the art for an improvement to existing wire baskets used to fry food. In this regard the present invention substantially fulfills these needs.

### SUMMARY OF THE INVENTION

In view of the foregoing disadvantages inherent in the known types of wire baskets used to fry food now present in the art, the present invention provides a fry basket with ergonomic handle wherein the same can retain and receive a wire mesh basket therein, the framework having an ergonomic handle portion and grip in order to provide more comfort for prolonged periods of time, thereby reducing the chance for the user to develop fatigue or injury while manipulating the wire basket. The present fry basket with ergonomic handle comprises a plurality of wires forming a wire frame. The wire frame defines a base receptacle that retains and receives a wire mesh basket therein. The base receptacle has a pair of open sidewalls, a lower front wall, a higher rear wall, and an upper open horizontal wall. The plurality of wires of the higher rear wall converge as they extend upwardly to form a generally vertical connection portion that connects the higher rear wall to a handle portion. The handle portion, in turn, extends rearwardly from the higher rear wall at a zero-degree angle with respect to at least one upper horizontal wire of the upper open horizontal wall. The handle portion also has a grip portion.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the fry basket with ergonomic handle with a complementary wire mesh basket.

FIG. 2 shows a rear perspective view of an embodiment of the fry basket with ergonomic handle, with a focus on a handle portion and a pair of wires forming a loop.

FIG. 3 shows a side view of an embodiment of the fry basket with ergonomic handle, with a focus on an angle at which the handle portion is disposed in relation to an upper open horizontal wall of a base receptacle and complementary wire mesh basket.

### DETAILED DESCRIPTION OF THE INVENTION

Reference is made herein to the attached drawings. Like reference numerals are used throughout the drawings to depict like or similar elements of the fry basket with ergonomic handle. For the purposes of presenting a brief and clear description of the present invention, a preferred embodiment will be discussed as used for the fry basket with ergonomic handle. The figures are intended for representative purposes only and should not be considered to be limiting in any respect.

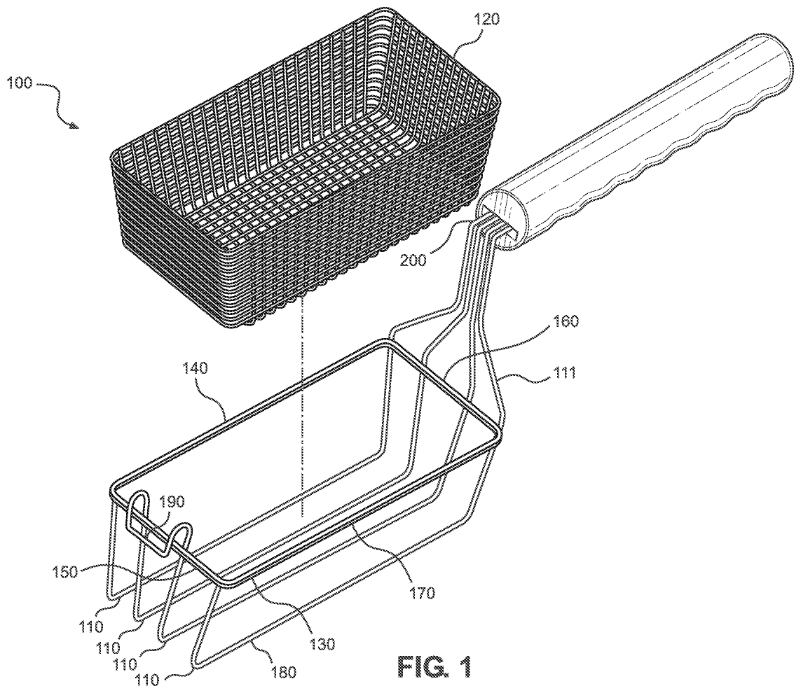

Referring now to FIG. 1, there is shown an exploded view of an embodiment of the fry basket with ergonomic handle with a complementary wire mesh basket. The fry basket with ergonomic handle 100 comprises a plurality of wires 110 forming a wire frame 111. In the shown embodiment, four wires 110 form the wire frame 111. The use of only four wires 110 enables a structure to be formed which can support a basket 120, while minimizing the amount of materials needed to construct the wire frame 111 and providing a stable framework for such a basket 120.

The wire frame 111 defines a base receptacle 130. The base receptacle 130 comprises a pair of open sidewalls 140, a front wall 150, a rear wall 160, and an upper open horizontal wall 170. In various embodiments, a height of the front wall 150 is lower than a height of the rear wall 160. In the shown embodiment, the upper open horizontal wall 170 is a single wire disposed around a perimeter of the base receptacle 130. In one embodiment, the upper open horizontal wall 170 provides a surface on which a perimeter lip of the basket 120 can rest. In one embodiment, a wire mesh basket 120 is configured to be removably received by the base receptacle 130. In the shown embodiment, the upper open horizontal wall 170 is sized to receive an entirety of the perimeter of the basket 120 therethrough. In a further embodiment, the upper open horizontal wall 170 is sized to secure a perimeter of the basket 120 within the base receptacle 130 via a friction fit between the upper open horizontal wall 170 and a top perimeter of the basket 120.

Each of the pair of open sidewalls 140 is defined on one end by the upper open horizontal wall 170 and on the other end by a wire of the plurality of wires 110 disposed at a downward angle therefrom. In one embodiment, the open sidewalls 140 are orthogonal to a plane of the upper open horizontal wall 170. In the shown embodiment, the pair of open sidewalls 140 gradually taper inwardly from the wider upper open horizontal wall 170 to a narrower lower floor portion 180. Such angled sidewalls 140 are desirable as they are able to match the contours and angles of a traditional basket 120.

The lower floor portion 180 is composed of a plurality of wires 110 and is configured to receive and support a basket 120 thereon. In the shown embodiment, the lower floor portion 180 is composed of four wires 110 that run in parallel to the plane of the upper open horizontal wall 170. The floor portion 180 is configured to support the weight of a full basket 120 containing food items such as French fries, onion rings, or the like. The open nature of the floor portion 180 enables hot oil from an oil bath to penetrate the base receptacle 130 and the basket 120 thereby enabling the hot oil to cook food held within the basket 120. Similarly, the oil can be drained from the basket 120 and the base receptacle 130 by nature of the open floor portion 180, thereby enabling a user to remove the basket 120 and fried food without retaining any oil.

In some embodiments, a hook 190 is disposed on a front surface of the base receptacle 130, the hook 190 configured to support the weight of a full base receptacle 130 and basket 120. The hook 190 can be used to elevate the fry basket with ergonomic handle 100 over a hot oil bath both securing the hook 190 to a complementary channel built into the bath. In this manner, the basket 120 can be filled with a desired food in preparation for submersion into the oil bath. The hook 190 can also be used to elevate and hold the fry basket with ergonomic handle 130 above the oil bath such that excess oil can drain and drip out of the base receptacle 130 and basket 120 back into the bath. In this manner, oil can be contained and recaptured by the oil bath eliminating a mess in a food preparation area. In the shown embodiment, a pair of wires 110 of the lower front wall 150 extend frontwardly and converge to form the hook 190.

The lower front wall 150 and the higher rear wall 160, similar to the sidewalls 140, are defined on one end by the upper open horizontal wall 170 and on the other end by a wire of the plurality of wires 110 disposed at a upward angle from the floor portion 180. In the shown embodiment, the lower front wall 150 and the higher rear wall 160 gradually taper inwardly from the wider upper open horizontal wall 170 to the narrower lower floor portion 180. Such angled front and rear walls 150, 160 are desirable as they are able to match the contours and angles of a traditional basket 120 in the same manner as the sidewalls 140.

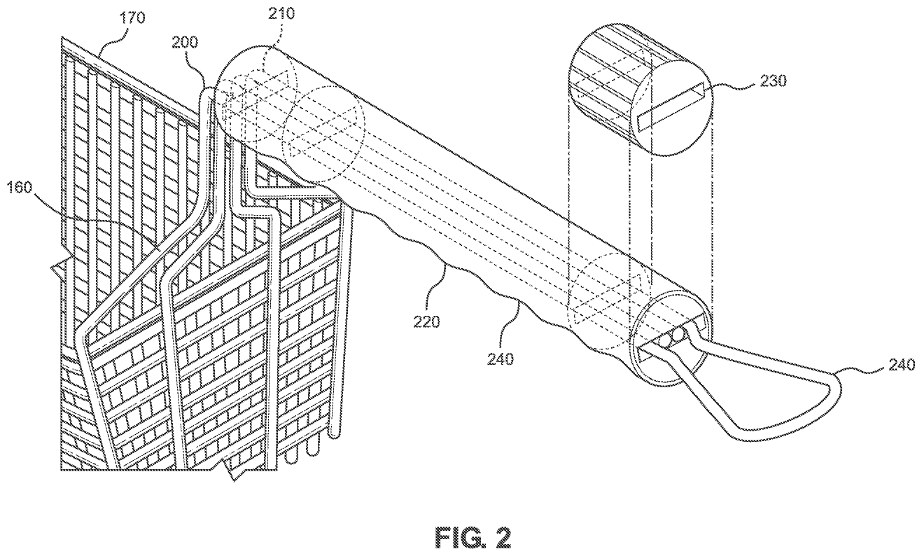

Referring now to FIG. 2, there is shown a rear perspective view of an embodiment of the fry basket with ergonomic handle, with a focus on a handle portion and a pair of wires forming a loop. The plurality of wires of the higher rear wall 160 converge as they extend upwardly to form a generally vertical connection point 200 that connects the higher rear wall 160 to a handle portion 210. In one embodiment, the handle portion 210 connects the higher rear wall 160 at a ninety-degree angle to the vertical connection point 200. The handle portion 210 extends rearwardly to provide a handle which a user can utilize to manipulate the fry basket with ergonomic handle and an associated basket. In the shown embodiment, the handle portion 210 extends rearwardly from the higher rear wall 160 at a zero-degree angle with respect to at least one upper horizontal wire of the upper open horizontal wall 170. In another embodiment, the handle portion 210 is disposed in a first horizontal plane that is parallel to a second horizontal plane defined by the upper open horizontal wall 170.

The handle portion 210 further comprises a grip 220. The grip 220 provides a comfortable section on which a user can grasp the device and manipulate the same. Contrary to devices currently present in the art, the present grip 220, coupled with the angle of the handle portion 210 in relation to the upper open horizontal wall 170 provides for comfort for prolonged periods of time, thereby reducing the chance for the user to develop fatigue or injury, such as irritation and inflammation of the muscles and tendons of the user, while manipulating the wire basket. In the shown embodiment, the grip 220 is a tubular member disposed over a portion of the handle portion 210. Further, in the shown embodiment, the tubular member includes a channel 230 that is sized and shaped to receive the plurality of wires that makeup the handle portion 210 therethrough. In some embodiments, the grip 220 is cylindrical to provide a smooth surface onto which the user may grasp the device. In other embodiments, the grip 220 comprises a circular cross-section. In one embodiment, the grip 220 further comprises a plurality of notches 240, wherein the notches 240 are sized and spaced apart to receive a plurality of fingers of a user. In other embodiments, a plurality of ridges, bumps, projections, and similar textures and protrusions are disposed on an exterior surface of the grip 220 to further aid the user in obtaining a firm and steady grasp of the present device. In the shown embodiment, the channel 230 is rectangular to prevent the grip 220 from rotating about the wires.

In the shown embodiment, a pair of wires of the handle portion 210 extend rearwardly out through the channel 230 in the grip 220. The pair of wires converge outside the channel 230 to form a loop 240. The loop 240 can be used to hang the device from a hook or other supporting object when the present device is not in use. In the shown embodiment, the loop 240 is annular to more easily receive the hook or other similar supporting device. In one embodiment, the loop 240 can be disposed on a terminal end of the handle portion 210. In an alternate embodiment, the loop 240 can comprise a single wire formed into an annular shape, or similar shape adapted to receive the hook or other similar supporting device.

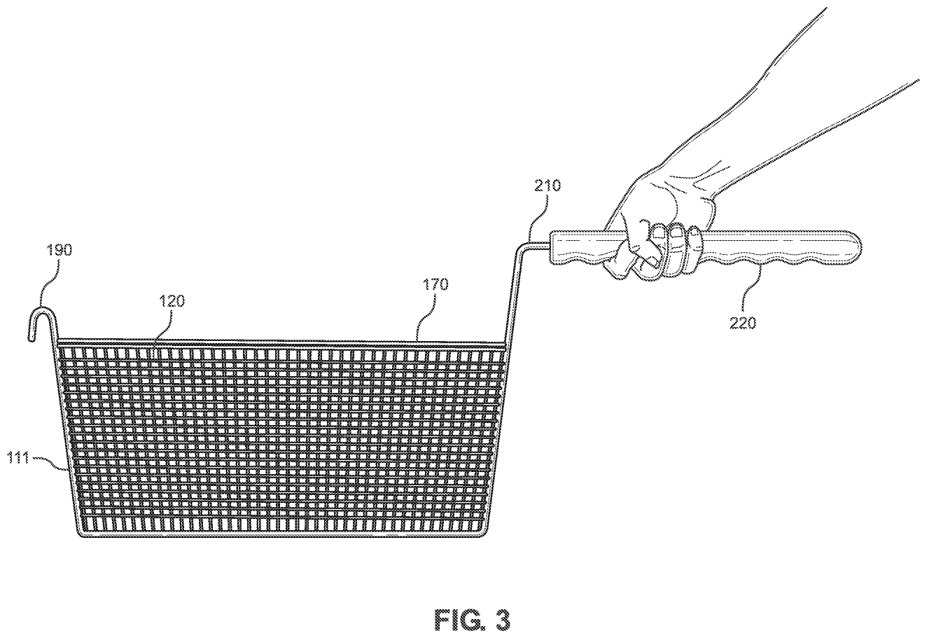

Referring now to FIG. 3, there is shown a side view of an embodiment of the fry basket with ergonomic handle, with a focus on an angle at which the handle portion is disposed in relation to an upper open horizontal wall of a base receptacle and complementary wire mesh basket. In use, the frame 111 can be rested on a counter surface, or similar surface, or can be secured to a desired surface, such as above a hot oil bath, via the hook 190. A basket 120 can then be filled with a desired food that the user desires to be submerged into the hot oil bath. The basket 120 can then be placed and secured within the frame 111. The user can then utilize the grip 220 of the handle portion 210 to manipulate the device into and out of the hot oil bath. The grip 220, coupled with the angle of the handle portion 210 in relation to the upper open horizontal wall 170 provides for comfort for prolonged periods of time, thereby reducing the chance for the user to develop fatigue or injury, such as irritation and inflammation of the muscles and tendons of the user, while manipulating the basket 120 and device into and out of the hot oil bath and also to and from a stable surface such as a countertop.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fry basket with ergonomic handle, comprising:
a plurality of wires forming a wire frame;
the wire frame defining a base receptacle;
the base receptacle comprising a pair of open sidewalls, a front wall, a rear wall, and an upper open horizontal wall;
the plurality of wires of the rear wall converge as they extend upwardly to form a generally vertical connection portion that connects the rear wall to a handle portion;
wherein the handle portion extends rearwardly from the rear wall at a zero-degree angle with respect to at least one upper horizontal wire of the upper open horizontal wall; and
the handle portion further comprising a grip.

2) The fry basket with ergonomic handle of claim 1, wherein the handle portion is disposed in a first horizontal plane that is parallel to a second horizontal plane defined by the upper open horizontal wall.

3) The fry basket with ergonomic handle of claim 1, wherein the handle portion connects to the rear wall at a ninety-degree angle at the vertical connection portion.

4) The fry basket with ergonomic handle of claim 1, wherein the grip is tubular.

5) The fry basket with ergonomic handle of claim 1, wherein the grip is cylindrical.

6) The fry basket with ergonomic handle of claim 1, wherein the grip comprises a circular cross-section.

7) The fry basket with ergonomic handle of claim 1, wherein the grip further comprises a plurality of notches, wherein the notches are sized and spaced apart to receive a plurality of fingers of a user.

8) The fry basket with ergonomic handle of claim 1, wherein a pair of wires of the front wall further converge to form a hook and extend frontwardly and over the upper open horizontal wall.

9) The fry basket with ergonomic handle of claim 1, wherein the pair of open sidewalls gradually taper inwardly from a wider upper open horizontal wall to a narrower lower floor portion.

10) The fry basket with ergonomic handle of claim 1, wherein the front wall and the rear wall gradually taper inwardly from a wider upper open horizontal wall to a narrower lower floor portion.

11) A fry basket with ergonomic handle, comprising:
a plurality of wires forming a wire frame;
the wire frame defining a base receptacle;
the base receptacle comprising a pair of open sidewalls, a lower front wall, a higher rear wall, and an open horizontal wall;
the plurality of wires of the higher rear wall converge as they extend upwardly to form a generally vertical connection portion that connects the higher rear wall to a handle portion;
wherein the handle portion extends rearwardly from the higher rear wall at a zero-degree angle with respect to at least one upper horizontal wire of the upper open horizontal wall;
the handle portion further comprising a grip;
a pair of wires of the handle portion extending rearwardly out through a channel in the grip; and
wherein the pair of wires converge outside the channel to form a loop.

12) The fry basket with ergonomic handle of claim 11, wherein the handle portion is disposed in a first horizontal plane that is parallel to a second horizontal plane defined by the upper open horizontal wall.

13) The fry basket with ergonomic handle of claim 11, wherein the grip further comprises a plurality of notches, wherein the plurality of notches is sized and spaced apart to receive a plurality of fingers of a user.

14) The fry basket with ergonomic handle of claim 11, wherein a pair of wires of the lower front wall further extend frontwardly and converge to form a hook.

15) The fry basket with ergonomic handle of claim 11, wherein the pair of open sidewalls gradually taper inwardly from a wider upper open horizontal wall to a narrower lower floor portion.

16) The fry basket with ergonomic handle of claim 11, wherein the lower front wall and the higher rear wall gradually taper inwardly from a wider upper open horizontal wall to a narrower lower floor portion.

17) A fry basket with ergonomic handle, comprising:
a plurality of wires forming a wire frame;
the wire frame defining a base receptacle and a wire mesh basket configured to be
removably received by the base receptacle;
the base receptacle comprising a pair of open sidewalls, a front wall, a rear wall, and an open horizontal wall;
the plurality of wires of the rear wall converge as they extend upwardly to form a generally vertical connection portion that connects the rear wall to a handle portion;
wherein the handle portion extends rearwardly from the rear wall at a zero-degree angle with respect to at least one upper horizontal wire of the upper open horizontal wall;
the handle portion further comprising a grip;
a pair of wires of the handle portion extend rearwardly out through a rear opening in the handle portion; and
wherein the pair of wires converge outside the rear opening to form a loop.
